(19) United States
(12) Patent Application Publication
(10) Pub. No.: US 2002/0103717 A1
(43) Pub. Date: Aug. 1, 2002

(54) Systems and methods for ensuring deliverable quality compliance

(76) Inventors: Stacey J. Swart, Fort Collins, CO (US); Meredith D. Mathews, Loveland, CO (US)

Correspondence Address: HEWLETT-PACKARD COMPANY, Intellectual Property Administration, P.O. Box 272400, Fort Collins, CO, 80527-2400, US

(21) Appl. No.: 09/774,957

(22) Filed: Jan. 31, 2001

(51) Int. Cl. G06F 17/60

(52) U.S. Cl. 705/26

(57) ABSTRACT

A preferred method includes the steps of: (1) communicating a request for deliverables to a provider of deliverables, with the request including a compliance guideline; and (2) receiving information corresponding to a sample of the deliverables provided by the provider. Preferably, the compliance guideline includes quality standards to be embodied in the deliverables to be provided, and the information corresponding to a sample of the deliverables contains compliance information regarding compliance of the sample with the quality standards of the compliance guideline. Systems and computer readable media also are provided.

### BACKGROUND OF THE INVENTION

1. Field of the Invention

The present invention generally relates to deliverables, e.g., technical manuals, advertising literature, items which display company logos, etc., as well as non-printed materials, such as web sites, for example, among others, that typically are requested by an entity and provided to the entity by a vendor, for example. More specifically, present invention relates to systems and methods for ensuring compliance of the deliverables with quality standards established by the entity requesting the deliverables.

2. Description of the Related Art

Oftentimes, an entity may place an order for deliverables with an outside organization, e.g., a print vendor, because it is inefficient for the entity to produce such deliverables “in-house.” As utilized herein, the term “deliverables” refers to materials, such as printed materials, e.g., technical manuals, advertising literature, items which display company logos, etc., as well as non-printed materials, such as web sites, for example, among others.

Heretofore, an entity desiring production of such deliverables (such an entity may be referred to herein as a “requester of deliverables,” or merely “requester”) by a vendor typically would meet with a vendor (such a vendor may be referred to herein as a “provider of deliverables,” or merely “provider”). The entity then provides the vendor with sufficient information for producing the deliverables. Thereafter, the vendor typically produces a sample or “blueline,” which is provided to the entity for proofing. Upon receipt of the blueline, the entity proofs the blueline to determine whether the blueline has been properly produced. If it is determined that the blueline does not comply with quality control standards of the entity, the entity typically returns the blueline to the vendor and requests that various aspects of the blueline be changed. Unfortunately, however, revising of the blueline by the vendor and further proofing of the blueline by the entity may take place numerous times, thereby consuming time and, potentially, other resources of both the vendor and the entity.

Therefore, there is a need for improved systems and methods which address these and other shortcomings of the prior art.

### SUMMARY OF THE INVENTION

Briefly described, the present invention relates to deliverables which typically are requested by a requester of deliverables and which are provided by a provider of deliverables. In this regard, some embodiments may be construed as providing methods for ensuring quality compliance of deliverables, such as those deliverables provided by a provider. In a preferred embodiment, the method includes the steps of: (1) communicating a request for deliverables to a provider of deliverables, with the request including a compliance guideline; and (2) receiving information corresponding to a sample of the deliverables provided by the provider. Preferably, the compliance guideline includes quality standards to be embodied in the deliverables to be provided, and the information corresponding to a sample of the deliverables contains compliance information regarding compliance of the sample with the quality standards of the compliance guideline.

Other embodiments may be construed as providing systems for ensuring quality compliance of deliverables. In this regard, a preferred embodiment includes a request for deliverables and a communication device. The request preferably incorporates a compliance guideline, which specifies quality standards to be embodied in the deliverables to be provided. Additionally, the communication device is configured to communicate the request for deliverables to a provider of deliverables and receive information corresponding to a sample of the deliverables provided by the provider. Such information preferably contains compliance information regarding compliance of the sample with the quality standards of the compliance guideline.

Still other embodiments may be construed as providing computer readable media for ensuring quality compliance of deliverables. In this regard, a preferred embodiment includes logic configured to communicate a request for deliverables to a provider of deliverables, and logic configured to receive information corresponding to a sample of the deliverables provided by the provider. Preferably, the request includes a compliance guideline, with the compliance guideline including quality standards to be embodied in the deliverables to be provided. The information, which is provided by the provider, preferably contains compliance information regarding compliance of the sample with the quality standards of the compliance guideline.

Other features and advantages of the present invention will become apparent to one with skill in the art upon examination of the following drawings and detailed description.

### BRIEF DESCRIPTION OF THE SEVERAL VIEWS OF THE DRAWINGS

The invention can be better understood with reference to the following drawings. The components in the drawings are not necessarily to scale, emphasis instead being placed upon clearly illustrating the principles of the present invention. Moreover, in the drawings, like reference numerals designate corresponding parts throughout the several views.

FIG. 1 is a schematic diagram depicting a preferred embodiment of the present invention.

FIG. 2 is a block diagram depicting a representative process implemented by a preferred embodiment of the present invention.

FIG. 3 is a processor-based system which may be employed by the present invention.

FIG. 4 is a flowchart depicting preferred functionality of the representative embodiment of FIG. 3.

FIG. 5 is a flowchart depicting preferred functionality of the representative embodiment of FIG. 3.

FIG. 6 is a schematic diagram depicting a preferred user interface for implementing the present invention shown in the representative embodiments of FIGS. 3-5.

### DETAILED DESCRIPTION OF A PREFERRED EMBODIMENT

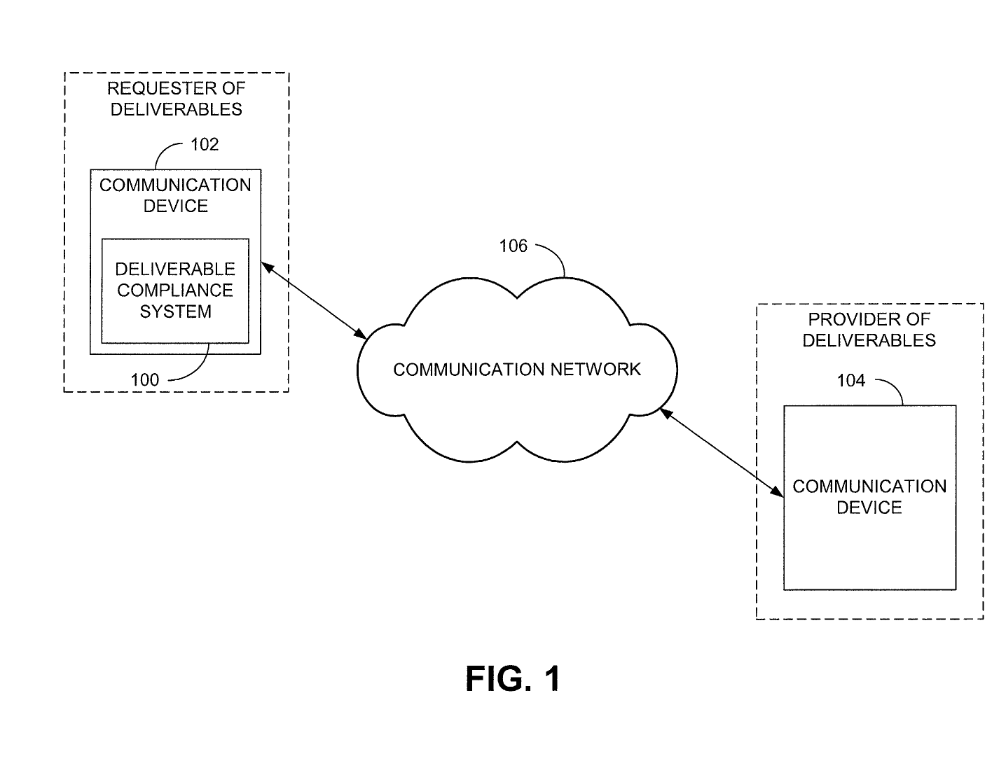

Reference will now be made in detail to the description of the invention as illustrated in the drawings with like numerals indicating like parts throughout the several views. As depicted in FIG. 1, a preferred embodiment of the deliverable compliance system 100 of the present invention may be utilized by a requester of deliverables to communicate information to a provider of deliverables, such as a print vendor. More specifically, in some embodiments, the deliverable compliance system 100 may cooperate with a communication device 102 of the requester so as to provide compliance guidelines to the provider of deliverables. For instance, such compliance guidelines may be communicated to a communication device 104 of the provider of deliverables via a communication network 106. For example, and not for the purpose of limitation, such a communication network may include the Internet.

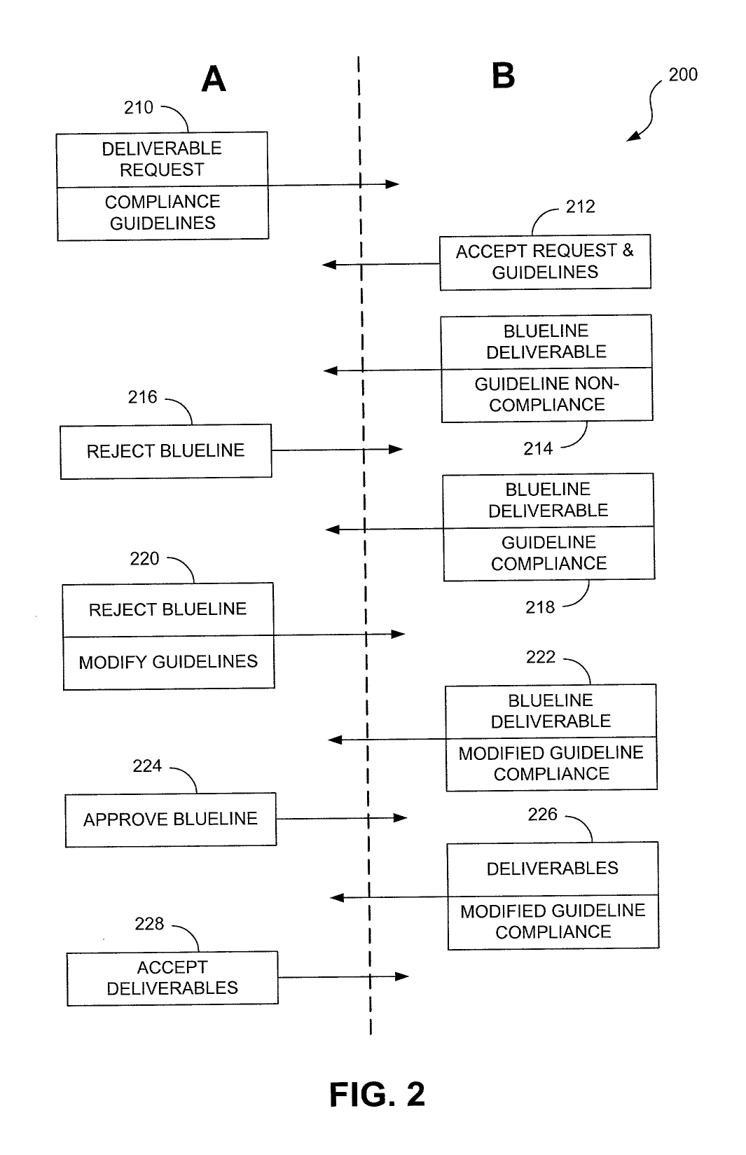

Referring now to FIG. 2, which depicts a representative deliverable transaction process 200, representative transactions facilitated by a preferred embodiment of the deliverable compliance system 100 will be described in greater detail. As shown in FIG. 2, transactions (depicted by blocks) appearing to the left of the dashed line are to be attributed to an entity A, i.e., a requester of deliverables, and those transactions appearing to the right of the dashed line are to be attributed to an entity B, i.e., a provider of deliverables. Thus, by utilizing a preferred embodiment of the deliverable compliance system of the present invention, a requester of deliverables may provide a request for deliverables and an associated compliance guideline(s) to a provider of deliverables (depicted in block 210). Preferably, the compliance guidelines include information by which the provider is to proof or review the requested deliverables, preferably, prior to sending such deliverables to the requester. In block 212, the provider may accept the request for deliverables and the associated guidelines, and then may inform the requester of the acceptance. Thereafter, such as depicted in block 214, a blueline or sample deliverable may be provided to the requester for proofing. As depicted in block 214, however, it is to be assumed that the blueline deliverable provided to the requester for proofing does not comply with the compliance guidelines. Thus, as depicted in block 216, the present invention may facilitate rejection of the non-complying blueline.

In response to the rejection of the non-complying blueline, the provider may revise the blueline and provide the revised blueline to the requester, as depicted in block 218. As depicted therein, it is to be assumed that the revise deliverable complies with the issued guidelines.

As mentioned hereinfore, upon receipt of an acceptable blueline deliverable, i.e., a blueline deliverable in compliance with the issued guidelines, the requester may accept the blueline, thereby enabling the provider to proceed with production of the requested deliverables. However, the blueline deliverable, which is otherwise in compliance with the issued guidelines, also may be rejected (depicted in block 220). In those instances, such as where a characteristic of the blueline deliverable is below expected quality standards but the particular characteristic was not specifically mentioned in the originally issued compliance guidelines, the compliance guidelines may be modified by the requester. Thereafter, the provider may again revise the blueline deliverable based upon characteristics recited in the modified compliance guidelines.

Once the revised blueline, which now is in compliance with the modified guidelines, is provided to the requester (depicted in block 222), the revised blueline may be approved by the requester (depicted in block 224). In response thereto, the provider may begin producing deliverables in accordance with the modified compliance guidelines. Once the deliverables have been produced by the provider and delivered to the requester (depicted in block 226), the deliverables may be accepted, such as depicted in block 228.

As may be seen in the representative process diagram depicted in FIG. 2, the steps of providing a blueline and proofing a blueline may occur at multiple instances throughout the transaction. However, it has been determined that the present invention may facilitate a more efficient process as the compliance guidelines tend to remove much of the guesswork associated with a provider of deliverables providing an appropriately compliant blueline for proofing by a requester. More specifically, the compliance guidelines may enable the provider of deliverables to conduct a quality assurance check of the blueline that corresponds to a quality assurance check typically conducted by the requester of the deliverables, thereby potentially alleviating the necessity of the requester carrying out such a quality assurance check.

Some embodiments of the present invention may be implemented in hardware, software, firmware, or a combination thereof, while still other embodiments may be facilitated, at least in part, without computer implementation. In a preferred embodiment, however, the deliverable compliance system is implemented as a software package, which can be adaptable to run on different platforms and operating systems as shall be described further herein. In particular, a preferred embodiment of the deliverable compliance system, which comprises an ordered listing of executable instructions for implementing logical functions, can be embodied in any computer-readable medium for use by or in connection with an instruction execution system, apparatus, or device, such as a computer-based system, processor-containing system, or other system that can fetch the instructions from the instruction execution system, apparatus, or device, and execute the instructions.

In the context of this document, a “computer-readable medium” can be any means that can contain, store, communicate, propagate or transport the program for use by or in connection with the instruction execution system, apparatus, or device. The computer readable medium can be, for example, but is not limited to, an electronic, magnetic, optical, electromagnetic, infrared, or semi-conductor system, apparatus, device, or propagation medium. More specific examples (a non-exhaustive list) of the computer-readable medium would include the following: an electrical connection having one or more wires, a portable computer diskette, a random access memory (RAM), a read-only memory (ROM), an erasable, programmable, read-only memory (EPROM or Flash memory), an optical fiber, and a portable compact disk read-only memory (CDROM). Note that the computer-readable medium could even be paper or another suitable medium upon which the program is printed, as the program can be electronically captured, via for instance, optical scanning of the paper or other medium, then compiled, interpreted, or otherwise processed in a suitable manner, if necessary, and then stored in a computer memory.

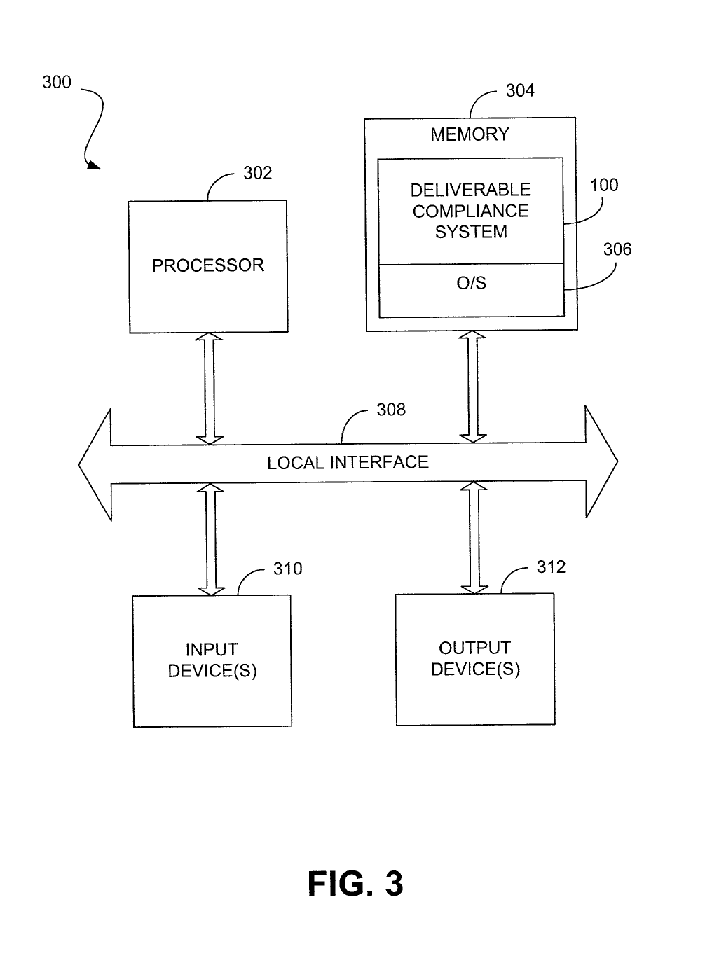

In this regard, FIG. 3 illustrates a typical computer or processor-based system 300 which may facilitate the deliverable compliance system 100 of the present invention. As shown in FIG. 3, a computer system 300 generally comprises a processor 302 and a memory 304 with an operating system 306. Herein, the memory 304 may include volatile and/or nonvolatile memory elements, such as RAM or ROM. The processor 302 accepts instructions and data from memory 304 over a local interface 308, such as a bus(es). The system also includes an input device(s) 310 and an output device(s) 312. Examples of input devices may include, but are not limited to, a serial port, a scanner, or a local access network connection. Examples of output devices may include, but are not limited to, a video display, a Universal Serial Bus, or a printer port. Generally, this system may run any of a number of different platforms and operating systems, including, but not limited to, HP-ux™, Linux™, UniX™, Sun Solaris™ or Windows NT™ operating systems. The deliverable compliance system 300 of the present invention, the functions of which shall be described hereinafter, may reside in memory 304 and may be executed by the processor 302.

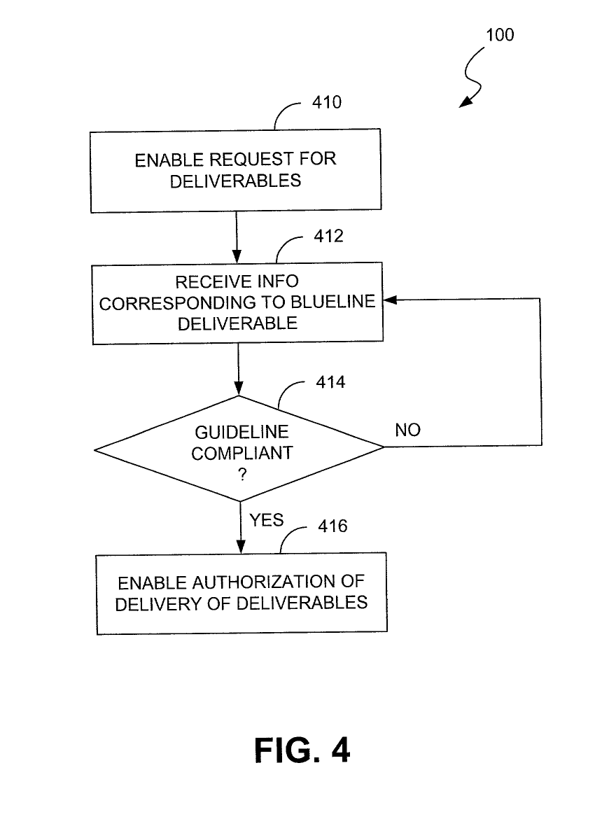

Referring now to FIG. 4, the flowchart depicted therein shows the functionality of a preferred implementation of the deliverable compliance system 100 depicted in FIG. 3. In this regard, each block of the flowchart represents a module segment or portion of code which comprises one or more executable instructions for implementing the specified logical function or functions. It should also be noted that in some alternative implementations the functions noted in the various blocks may occur out of the order depicted in FIG. 4. For example, two blocks shown in succession in FIG. 4 may, in fact, be executed substantially concurrently where the blocks may sometimes be executed in the reverse order depending upon the functionality involved.

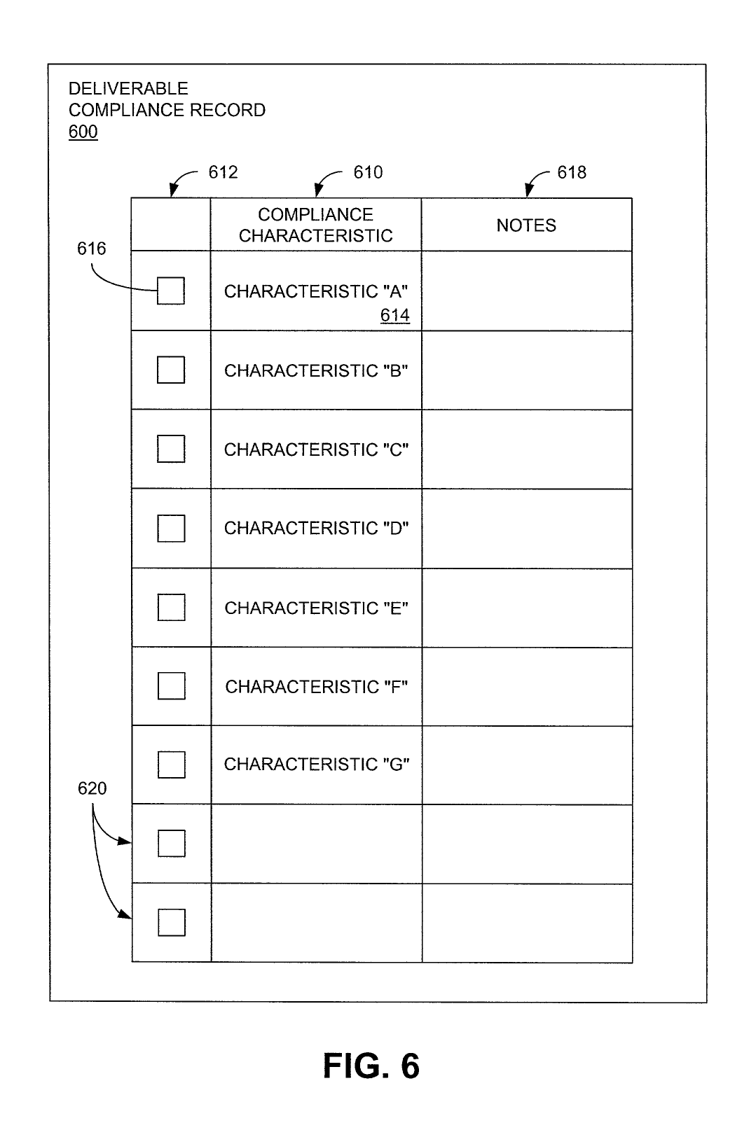

As depicted in FIG. 4, the functionality of a preferred embodiment of the deliverable compliance system may be construed as beginning at block 410 where a request for preparation of deliverables is enabled. For instance, in those embodiments enabling such a request, the deliverable compliance system may facilitate communication of the request to an intended provider of the deliverables, in which case, enabling the request may include enabling a request for deliverables form to be completed by the requester, and then enabling the form to be communicated to the intended provider of the deliverables. Additionally, the request for deliverables preferably includes compliance guidelines, which may be provided in the form of a deliverable compliance record (described hereinafter in relation to FIG. 6), among others, that are intended to be utilized by the provider to ensure that the deliverables meet predetermined criteria or characteristics established and/or promulgated by the requester. Such a request for deliverables form may be provided in numerous configurations, provided that the form is capable of communicating sufficient information to permit the production of a sample or blueline deliverable by the provider. All such configurations of forms are considered well within the scope of the present invention.

Communication of the request for deliverables form to an intended provider also may be provided in various manners. For instance, as mentioned hereinbefore in regard to FIG. 1, the request may be communicated via a communications network, e.g., the Internet, and associated communications devices, e.g., modems, thereby permitting the intended provider to receive information corresponding to the request for deliverables. Thus, in some embodiments, the request for deliverables form may be communicated by email from the requester to the intended provider, for instance.

As mentioned hereinbefore, in response to receiving a request for deliverables and associated compliance guidelines, a provider of deliverables preferably prepares a sample of the deliverable or blueline that is to be proofed by the requester. Thus, as depicted in block 412, the deliverable compliance system preferably receives information corresponding to the blueline. Such information may include, among others, an affirmation that the blueline is in compliance with the requirements of the compliance guidelines previously promulgated by the requester, an actual physical specimen of the blueline, and/or, in those instances where the blueline is adaptable for reproduction by the requester (such as when the blueline may be produced in an electronic format, e.g., a graphics file, Web site, etc.), information sufficient to enable the requester to produce and/or proof the blueline. Thereafter, a determination may be made as to whether the blueline complies with the issued compliance guidelines. In some embodiments, such a determination may be facilitated automatically by the deliverable compliance system (described in detail hereinafter). If it is determined, such as in block 414, that the blueline does not comply with the guidelines, the process may return to block 410 where the guidelines may be re-communicated to the provider. If, however, the blueline does comply with the compliance guidelines, the process may proceed to block 416 where authorization to deliver the deliverables may be enabled.

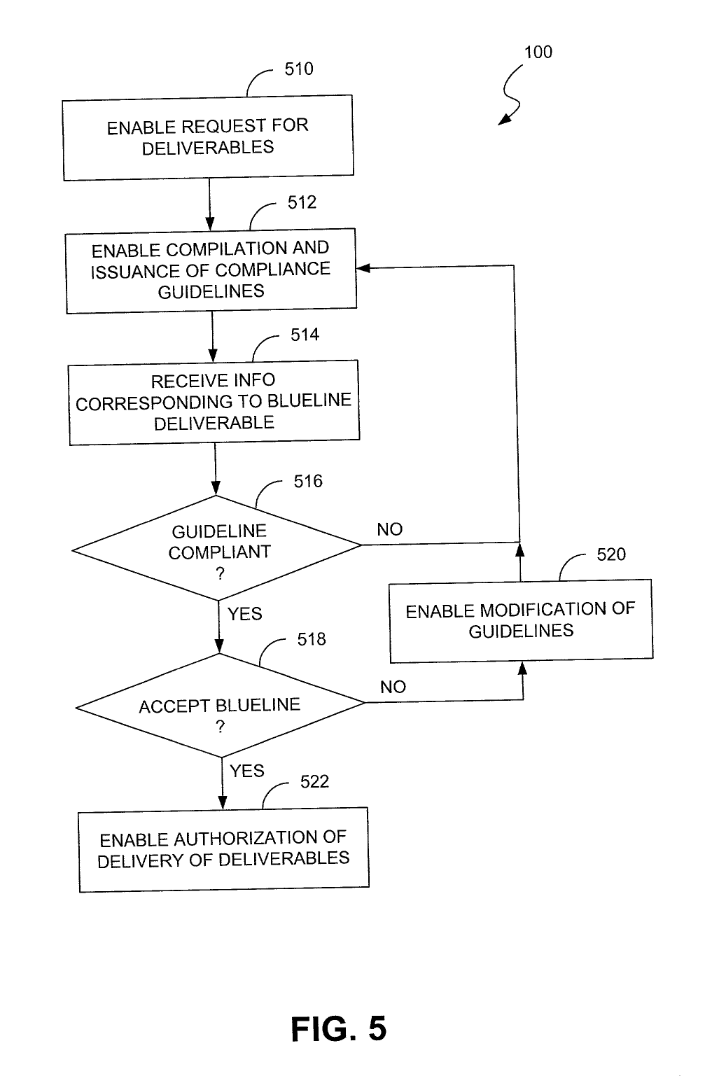

As depicted in FIG. 5, the functionality of an alternative embodiment of the deliverable compliance system 100 is presented which may be construed as beginning at block 510. As shown therein, a request for preparation of deliverables preferably is enabled in block 510. For instance, the deliverable compliance system may facilitate preparation of the request which is to be communicated to an intended provider of the deliverables. Proceeding to block 512, compilation and/or issuance of compliance guidelines are enabled. For instance, the deliverable compliance system may facilitate selection of compliance guidelines appropriate for a particular request for deliverables and may facilitated communication of the compliance guidelines as well as the request for deliverables to an intended provider of the deliverables. As described hereinbefore in relation to the flowchart of FIG. 4, communication of the request for deliverables and any associated compliance guidelines may be provided in various manners, with all such manners being considered well within the scope of the present invention.

As depicted in block 514, information regarding a blueline deliverable is received. Thereafter, such as in block 516, a determination may be made as to whether the blueline complies with the issued compliance guidelines. If it is determined, that the blueline does not comply with the guidelines, the process may return to block 512 where the guidelines may be re-communicated to the provider. If, however, the blueline does comply with the previously communicated guidelines, a further determination may be made as to whether the blueline is accepted by the requester (block 518). If the blueline is not accepted, such as where a previously unanticipated quality assurance characteristic is evident in the blueline, the process may proceed to block 520 where modification of the compliance guidelines may be enabled. Thereafter, the process may proceed to block 512 where the guidelines, e.g., the modified guidelines, may be communicated to the provider and the process may proceed as described hereinbefore. If, however, the blueline is accepted, the process may proceed to block 522 where authorization to deliver the deliverables may be enabled.

As mentioned hereinbefore, compliance guidelines may be communicated to the provider of deliverables in numerous manners. For instance, compliance guidelines may be communicated to the provider via e-mail, facsimile, etc., and, in some embodiments, may merely be communicated as a printed hard copy of a compliance guideline. Regardless of the particular format utilized, the compliance guidelines may facilitate a quality assurance check of the deliverables to be provided and may potentially alleviate the requester of the necessity of conducting a thorough proof of a submitted blueline.

As a requester may provide compliance guideline information to a provider in various formats, and a provider may provide information corresponding to compliance of a blueline in regard to the compliance guidelines in various formats, reference is now made to FIG. 6. In this regard, a representative embodiment of a deliverable compliance record 600 is depicted in FIG. 6. Such a compliance record facilitates communication of the compliance guideline, such as through the use of compliance characteristics which appear in a portion of the record, such as in column 610. Additionally, associated with column 610 is a column 612 which is adapted for receiving an indicia indicating whether the particular compliance characteristic is embodied in a deliverable, e.g., the blueline. For instance, in preparation for providing a requester with a blueline deliverable, the provider preferably refers to the deliverable compliance record 600. By so doing, the provider preferably analyzes each annotated compliance characteristic and determines whether the characteristic is present in the blueline. Thus, in regard to a particular blueline, the provider should determine whether characteristic A (614) is embodied in the blueline. If it is determined that characteristic A is embodied in the blueline, the provider may appropriately mark or annotate a corresponding portion of column 612, such as block 616, thereby indicating that the characteristic A is present. Thus, a corresponding mark in each of the blocks of column 612 associated with a compliance characteristic provided in column 610 is to be marked prior to the provider providing the requester with a blueline deliverable for proofing.

Additionally, a column 618 may be provided within which various notes or annotations by the provider and/or the requester may be made. Additional rows 620 may be provided on the compliance record to facilitate modification of the compliance guidelines based upon unforeseen and/or unanticipated quality assurance issues which may arise during processing. Thus, if an additional compliance characteristic needs to be added to the compliance guidelines, one or more of the additional rows may be utilized.

It should be noted that the deliverable compliance record of the present invention may be embodied in numerous media and may be provided in various configurations and/or formats. More specifically, some embodiments of the present invention may be embodied as a printed hard copy, which may be physically delivered to the provider. In other embodiments, the deliverable compliance record may be configured as a graphical user interface (GUI) which may be facilitated by the deliverable compliance system 100 (depicted in FIG. 3, for example). Thus, by utilizing a GUI implementation of the deliverable compliance record, the representative deliverable transaction process (such as the representative process depicted in FIG. 2) may be facilitated entirely electronically, whereby a failure of a compliance characteristic to be embodied in a blueline deliverable may prompt automatic rejection of the blueline by the deliverable compliance system. For instance, the deliverable compliance record may be communicated from the requester to the provider via email. Thereafter, when an appropriate blueline has been produced and is ready for submission to the requester for proofing, the provider may appropriately annotate the deliverable compliance record, such as by marking the appropriate boxes in column 612, and then sends the annotated record and an electronic copy of the blueline to the requester. Preferably, upon receipt of the information from the provider corresponding to the blueline, the deliverable compliance system may evaluate whether the compliance guidelines have been complied with, such as by determining whether the appropriate annotations appear on the deliverable compliance record. Thus, in these embodiments, a representative of the requester need not be concerned with proofing a blueline until, at a minimum, the requester indicates that the blueline complies with the previously issued compliance guidelines.

For example, and not for the purpose of limitation, the following is a list of representative compliance guidelines: title on cover and title page match; copyright date and edition date on front cover matches back cover, front page (inside cover), and printing history page; manual part number on cover matches bar code; footer information is correct for left and right pages; pagination starts over at one for each chapter, appendix, glossary, and index (1-1, 2-1); pagination is consecutive for table of contents, table of tables, and table of figures; no widows/orphans or other odd line breaks; figures are numbered consecutively; tables are numbered consecutively; shading is consistent in tables and figures; graphics are visible/printing correctly and call outs are visible/printing correctly; no additional lines on graphics; bleeder tabs are inserted for each chapter and appendix, and run off the page edge; content does not overlap tabs; the hand off includes a PDF on disk, a printed version, and cover art (including bar code); cover art is included for front and back cover; the title and part numbers are correct; the size if all files is set for 7.5 by 9 inches; every page on the PDF has been double checked to insure the layout and formats have been converted correctly; font has been verified.

The foregoing description has been presented for purposes of illustration and description. It is not intended to be exhaustive or to limit the invention to the precise forms disclosed. Modifications or variations are possible in light of the above teachings. The embodiment or embodiments discussed, however, were chosen and described to provide the best illustration of the principles of the invention and its practical application to thereby enable one of ordinary skill in the art to utilize the invention in various embodiments and with various modifications as are suited to the particular use contemplated. All such modifications and variations, are within the scope of the invention as determined by the appended claims when interpreted in accordance with the breadth to which they are fairly and legally entitled.

Therefore, at least the following is claimed:

1. A method for ensuring quality compliance of deliverables, the method comprising the steps of:
communicating a request for deliverables to a provider of deliverables, the request including a compliance guideline, the compliance guideline including quality standards to be embodied in the deliverables to be provided; and
receiving information corresponding to a sample of the deliverables provided by the provider, the information containing compliance information regarding compliance of the sample with the quality standards of the compliance guideline.

2. The method of claim 1, further comprising the step of-.
rejecting the sample of the deliverables provided by the provider if the compliance information indicates non-compliance of the sample with the quality standards of the compliance guideline.

3. The method of claim 1, further comprising the step of:
accepting the sample of the deliverables provided by the provider if the compliance information indicates compliance of the sample with the quality standards of the compliance guideline.

4. The method of claim 1, wherein the step of communicating a request for deliverables comprises the steps of:
enabling a request for deliverables form to be completed by the requester, the request for deliverables form including information regarding the deliverables to be provided; and
enabling the request for deliverables form to be communicated to the provider of the deliverables.

5. The method of claim 1, wherein the step of receiving information corresponding to a sample of the deliverables comprises the steps of:
receiving sample information, the sample information enabling proofing of the sample; and
reviewing the sample in reference to the compliance guideline.

6. The method of claim 1, wherein the step of receiving information corresponding to a sample of the deliverables comprises the step of:
providing a graphical user interface (GUI), the GUI enabling the provider of the deliverables to annotate compliance information regarding compliance of the sample with the quality standards of the compliance guideline.

7. The method of claim 1, wherein the step of communicating a request for deliverables comprises the steps of:
providing a graphical user interface (GUT), the GUI enabling a requester of deliverables to compile a compliance guideline associated with deliverables to be provided; and
communicating the compliance guideline to the provider via a communications network.

8. The method of claim 7, wherein the step of providing a graphical user interface comprises the steps of:
providing a deliverable compliance record having a first portion and a second portion, the first portion containing information corresponding to compliance characteristics intended to be embodied in the deliverables, the second portion being adapted for receiving indicia indicating whether particular ones of the compliance characteristics represented in the first portion of the deliverable compliance record are embodied in a deliverable;
enabling the requester of the deliverables to select compliance characteristics to be provided by the deliverable compliance record; and
enabling the provider of the deliverables to provide the indicia indicating whether particular ones of the compliance characteristics represented in the first portion of the deliverable compliance record are embodied in the sample of the deliverable provided by the provider.

9. A system for ensuring quality compliance of deliverables, said system comprising:
means for producing a request for deliverables, said request including a compliance guideline, said compliance guideline including quality standards to be embodied in the deliverables to be provided; and
a communication device configured to communicate said request for deliverables to a provider of deliverables and receive information corresponding to a sample of the deliverables provided by the provider, said information containing compliance information regarding compliance of the sample with said quality standards of said compliance guideline.

10. The system of claim 9, further comprising:
means for rejecting the sample of the deliverables provided by the provider if said compliance information indicates non-compliance of the sample with said quality standards of said compliance guideline.

11. The system of claim 9, further comprising:
means for accepting the sample of the deliverables provided by the provider if said compliance information indicates compliance of the sample with said quality standards of said compliance guideline.

12. The system of claim 9, wherein said request for deliverables is configured as a request for deliverables form to be completed by a requester of the deliverables, said request for deliverables form including information regarding the deliverables to be provided, and wherein said request for deliverables form is configured to be communicated to the provider of the deliverables via said communication device.

13. The system of claim 9, further comprising:
a graphical user interface (GUI), the GUI being configured to enable generation of said request for deliverables such that a requester of deliverables may create said compliance guideline associated with the deliverables to be provided.

14. The system of claim 13, wherein said GUI is further configured to enable the provider of the deliverables to annotate compliance information regarding compliance of the sample with said quality standards of said compliance guideline.

15. The system of claim 13, wherein said GUI is configured to provide a deliverable compliance record having a first portion and a second portion, said first portion containing information corresponding to compliance characteristics intended to be embodied in the deliverables, said second portion being adapted for receiving indicia indicating whether particular ones of the compliance characteristics represented in said first portion of said deliverable compliance record are embodied in a deliverable.

16. The system of claim 15, wherein said GUI is further configured to enable the provider of the deliverables to indicate whether particular ones of the compliance characteristics represented in said first portion of said deliverable compliance record are embodied in the sample of the deliverable provided by the provider.

17. A computer readable medium for ensuring quality compliance of deliverables, the computer readable medium comprising:
logic configured to communicate a request for deliverables to a provider of deliverables, the request including a compliance guideline, the compliance guideline including quality standards to be embodied in the deliverables to be provided; and
logic configured to receive information corresponding to a sample of the deliverables provided by the provider, the information containing compliance information regarding compliance of the sample with the quality standards of the compliance guideline.

18. The computer readable medium of claim 17, further comprising:
logic configured to reject the sample of the deliverables provided by the provider if the compliance information indicates non-compliance of the sample with the quality standards of the compliance guideline.

19. The computer readable medium of claim 17, further comprising:
logic configured to accepting the sample of the deliverables provided by the provider if the compliance information indicates compliance of the sample with the quality standards of the compliance guideline.

20. The computer readable medium of claim 17, wherein said logic configured to communicate a request for deliverables includes:
logic configured to enable a request for deliverables form to be completed by the requester, the request for deliverables form including information regarding the deliverables to be provided; and
logic configured to enable the request for deliverables form to be communicated to the provider of the deliverables.

21. The computer readable medium of claim 17, wherein said logic configured to receive information corresponding to a sample of the deliverables includes:
logic configured to receive sample information, the sample information enabling proofing of the sample; and
logic configured to proof the sample in reference to the compliance guideline.

22. The computer readable medium of claim 17, wherein said logic configured to communicate a request for deliverables includes:
logic configured to provide a graphical user interface (GUI), the GUI enabling a requester of deliverables to compile a compliance guideline associated with deliverables to be provided; and
logic configured to communicate the compliance guideline to the provider via a communications network.
